(19) United States
(12) Patent Application Publication
(10) Pub. No.: US 2002/0077955 A1
(43) Pub. Date: Jun. 20, 2002

(54) Full maturity option bond fund

(76) Inventor: Henry L. Ramm, Seabrook, TX (US)

Correspondence Address: Michael I. Kroll, 171 Stillwell Lane, Syosset, NY, 11791, US

(21) Appl. No.: 09/738,414

(22) Filed: Dec. 15, 2000

(51) Int. Cl. G06F 17/60

(52) U.S. Cl. 705/37

(57) ABSTRACT

The invention is a full maturity option bond fund that provides a bond fund wherein the investors have the option of specifying maturity dates for their investment that coincide with the maturity date of a debt securities held by the bond fund manager. Whereby the investor having held his bond fund investment until the debt security matures receives the full face value of the original investment. The invention also allows the investor to receive a cash credit for interest received relative to each maturity date selected less fund fees. The interest could be withdrawn as cash or reinvested in the fund at a selected maturity date.

### BACKGROUND OF THE INVENTION

1. Field of the Invention

The present invention relates generally to bond mutual funds and, more specifically, to a full maturity option bond fund whereby an investing entity is able to specify interest rates, less fund fees, based on predetermined maturity dates for bond investments which will result in a return of interest earned and, at a minimum, the full value of the original investment when the selected investor maturity date coincides with the bond investment maturity date.

Debt securities are issued by federal or state governments, municipalities, and corporation with a maturity date whereby the holders of said debt securities are repaid the face value at maturity. During the life of the debt securities, interest payments are paid at the interest rate stated on the note to the holders of said debt securities.

Most of these debt securities are purchased by institutional investors who package them in various risk graded portfolios that are offered to investors for purchase as bond fund units. The size of the fund and the price of the units vary depending on the institution offering the fund. But, basically the fund is paid interest by the bond issuers and the interest payments, deposited in the fund, contribute to increasing the value of the fund units. As the securities held by the fund mature or are called for early repayment the institutional investor replaces them with additional debt securities. When an investor cashes out their fund units, in whole or in part, they are paid a value based on the unit value existing on the day of redemption. The unit value for each day is determined by determining the market value of the securities in the fund plus whatever cash is on hand. The market values of debt securities, on any given day, generally fluctuate inversely with prevailing interest rates based on dates of maturity and directly with market emotions. During equity market declines, inflationary periods, or unstable political environments positive market sentiment in favor of debt securities may raise bond market values above their face value or pure interest adjusted values. Conversely during strong increasing equity markets, decreasing inflation, or stable political environments, negative market sentiment regarding debt securities may decrease market bond values below the interest adjusted values or the face value of the security. At the time of redemption by the investor, the unit values in the fund may be well below their original value in which case the investor fails to recover the interest earned, and the original unit value of the investment or, even at a minimum, the face value of the securities as they would convert to unit values.

The present invention is a bond fund that offers investors the option of holding their fund units until one or more maturity dates selected at the time of investment (which are matched by the debt securities held by the fund) or taking early redemption because either the bond (unit) values have increased above the original investment value or the investor decides to cash out for other reasons. The invention also allows the investor a means of utilizing interest proceeds as either cash for withdrawal or reinvestment in the fund. The fund expenses will be recovered from the interest payments received from the debt securities (bonds). If an investor redeems their fund units in whole or in part before the maturity dates selected, the fund units value will be determined by the existing market values of the units on date of redemption.

2Description of the Prior Art

There are other financial management systems designed for investment. Typical of these is U.S. Pat. No. 5,083,782 issued to Nilssen on Jan. 28, 1992.

Another patent was issued to Champion et al. on Jun. 30, 1992 as U.S. Pat. No. 5,126,936. Yet another U.S. Pat. No. 5,132,899 was issued to Fox on Jul. 21, 1992 and still yet another was issued on Nov. 16, 1993 to Earle as U.S. Pat. No. 5,262,942.

Another patent was issued to Finfrock et al. on Jan. 7, 1997 as U.S. Pat. No. 5,592,379. Yet another U.S. Pat. No. 5,884,287 was issued to Edesess on Mar. 16, 1999. Another was issued to Tull, Jr. et al. on Aug. 31, 1999 as U.S. Pat. No. 5,946,667. Another was issued to O'Shaughnessy on Nov. 2, 1999 as U.S. Pat. No. 5,978,778 and still yet another was issued on Jan. 25, 2000 to Nilssen. as U.S. Pat. No. 6,017,063.

### U.S. Pat. No. 5,083,782

### Inventor: Ole K. Nilssen

### Issued: Jan. 28, 1992

A financial institution, such as a bank, issues numerous uniquely coded certificates to various individual entities in exchange for monetary value received. The holder of each certificate is entitled to receive a certain average rate of income from the monetary value represented by that certificate; which average rate of income would generally be proportional to prevailing interest rate as well as to the monetary value represented by the certificate. To avoid the relatively high transaction costs associated with periodic payments of a relatively modest income to the holder of each of numerous individual certificates, a statistical method is used. By way of this statistical method, a relatively few of the numerous uniquely coded certificates are randomly chosen at the end of each of a continuous sequence of time periods, and all the income attributable to all the issued certificates for the associated time period is then paid to the holders of the relatively few certificates chosen for that time period. Alternatively, the earnings resulting from the monetary values received are simply retained and added to the total fund of money underlying the certificates, thereby causing the monetary value of each certificate to grow over time. Thus, the total earnings attributable to a given certificate is continuously cumulated and added to the value represented by that certificate.

### U.S. Pat. No. 5,126,936

### Inventor: Robert R. Champion et al.

### Issued: Jun. 30, 1992

A data processing apparatus and method controls and implements a goal-directed financial assets management system. The operative system receives investor deposits at selected levels of correspondence to established capital markets. A proportionality factor, or “market multiple” MM, is established as a measure of correspondence between the account and each market or asset of interest. The operative system periodically enters new account data and adjusts the individual accounts in response thereto. The system determines a net position change which is translated into aggregate purchase/sale orders of various market index futures contracts or other capital instruments. The system automatically adjusts the risk exposure in any asset category to prevent its reaching an excessive level. As a result, an account can never lose more than the amount deposited. The data processing system provides efficient operation and low transaction fees to the participating investors.

### U.S. Pat. No. 5,132,899

### Inventor: Philip J. Fox

### Issued: Jul. 21, 1992

The present invention combines data gathering and processing methodology with computer apparatus to produce a system whereby a list of stocks and a cash position is generated and purchased for investment and operating accounts. Specifically, the system integrates three areas of data: investment performance for investment managers (the investment manager database); federal Securities Exchange Commission (SEC) reports filed quarterly by investment managers (the government report database); and financial characteristics for a large number of stocks (the stock database). Various screens and criteria are applied to the three data areas. The investment managers in the investment manager database are screened to find investment managers with top performances who meet a series of other criteria. The government reports are screened based upon the largest stock holdings for the investment managers chosen in the first step. The stock database financial characteristics are applied against the stocks from the government reports.

### U.S. Pat. No. 5,262,942

### Inventor: Dennis M. Earle

### Issued: Nov. 16, 1993

A financial transaction network employs a shareholder network serviced by a host processor. The financial network maintains (n) number of mutual fund portfolios operating in different currencies. The host processor acts a communications switch validating incoming transaction requests and routing them to a central Transfer Agent system for execution. The host processor maintains central records that can be queried through the host. The Transfer Agent is responsible for updating the database. The financial network provides accessibility, speed and finality of settlement in transactions by using mutual fund shares in diverse currencies as substitutes for those currencies.

### U.S. Pat. No. 5,592,379

### Inventor: Dale B. Finfrock et al.

### Issued: Jan. 7, 1997

The instant invention is a method and apparatus for administering a program to senior citizens for managing and distributing the interest from pooled government bonds or the like. The program derived around a bond fund unit of various security offerings to specific groups of senior citizens having a common age and financial goal. As long as the participant is alive, the participant will share equally in an increasing income stream derived from the interest from the security due to the number of decreasing participants in a fixed pool based on the participant's initial investment. The income producing bonds jointly pooled and singularly administered based upon U.S. Treasury bonds whose resulting interest is distributed to the remainder of living participants while bond maturity value remains payable to the participant or their estate. The program aids the participants and managers involved with the program regarding Fund assets, statistical predictions, and dividend distribution.

### U.S. Pat. No. 5,884,287

### Inventor: Michael Edesess

### Issued: Mar. 16, 1999

The present invention is a computer-implemented system and method to create an optimal investment plan given wealth goals stated in probabilistic form, and to display the resulting probability distributions of wealth accumulations at future times where the method provides inputs for entering and storing in a computer target and fallback scenarios and required probabilities, computes rate of return values responsive to the user input, generates an efficient portfolio array, computes probabilities for the efficient portfolio array related to the rate of return values, iteratively compares the array probabilities so that the target and fallback scenario probabilities are satisfied and an optimum efficient portfolio is selected and then provides a graphical representation of the selected efficient portfolio.

### U.S. Pat. No. 5,946,667

### Inventor: Robert Stanley Tull, Jr.

### Issued: Aug. 31, 1999

A data processing system and method is disclosed for implementing and control of a financial debt instrument which is issued for a limited period of time and is traded as a listed security. The debt instrument is based on an underlying basket of stocks optimally selected to track an established capital market and its price also reflects accrued investment income and maintenance expenses. The data processing system receives input from the capital market and periodically evaluates the performance of the financial debt instrument, reporting its price to customers. Also disclosed is a data processing system for administering an investment group of such debt instruments designed to track the performance of several domestic and foreign markets, estimate their return and provide current price information to customers.

### U.S. Pat. No. 5,978,778

### Inventor: James P. O'Shaughnessey

### Issued: Nov. 2, 1999

The invention is in the field of using a computer to select corporate stocks for investment. Fifty stocks are selected from a database on the basis of certain criteria. The stocks are acquired in equal proportions, and the portfolio is rebalanced at the end of an annual term. A method of the present invention uses either a growth strategy, a value strategy, or both strategies. Growth Model 3 strategy selects the stocks with the best 1-year price performance from All Stocks (stocks with market capitalization more than $150 million) with earnings gains for five consecutive years that also have price-to-sales ratios below 1.5. Value Model 3 strategy selects market leading stocks with the highest dividend yields (excluding utilities so they do not dominate the list). Market leading stocks come from the Large Stocks Universe and have: more common shares outstanding than the average stock in the database, cashflows per share exceeding the database mean, and corporate sales that are 1.5 times the database mean. A stock portfolio may be constructed which uses both Growth Model 3 and Value Model 3 in chosen proportion to one another. At the end of an annual term, the amount of money generated by the two strategies is pooled and then re-invested in accordance with the chosen proportion (which may change over time).

### U.S. Pat. No. 6,017,063

### Inventor: Ole K. Nilssen

### Issued: Jan. 25, 2000

A financial and/or a commercial enterprise, such as a mutual funds operator and/or a general merchandise/product sales establishment, prices its various financial and/or commercial goods in certain basic pricing units and sells uniquely coded certificates denominated in such pricing units; which pricing units are of such nature as to be substantially unaffected by inflation. Then, at any later time the holder of such a certificate is entitled to exchange this certificate for financial and/or commercial goods equivalent in total pricing units to the denomination specified on the certificate, regardless of any intervening changes in dollar pricing of the various items of financial and/or commercial goods. Since the purchaser of a certificate helps pay for the inventory of financial and/or commercial goods underlying the certificates, each holder of such a certificate periodically receives an interest payment in the form of a pre-established probabilistic chance to win additional certificates.

While these financial investment systems may be suitable for the purposes for which they were designed, they would not be as suitable for the purposes of the present invention, as hereinafter described.

### SUMMARY OF THE PRESENT INVENTION

A primary object of the present invention is to provide a bond fund for investors.

Another object of the present invention is to provide a bond fund that purchases debt securities with callable and/or non-callable maturity dates.

Yet another object of the present invention is to provide a bond fund that credits interest payments to the investor's account as a cash value (and not as fund units). The amount of the interest payments would be related to the maturity dates originally selected by the investor. The investor may elect to withdraw all or portions of the earned interest and may designate all or portions of the earned interest for reinvestment in the fund in prescribed percentages at various selected maturity dates.

Another object of the present invention is to provide bond fund where investors can redeem their investments at specified maturity dates coinciding with the debt security maturity dates held by the fund and thereby receive as a minimum unit redemption values equivalent to full face value of the bond(s).

Yet another object of the present invention is to provide a bond fund where investors can redeem their investment prior to a specified maturity and receive a value based on the market value of the fund units existing on the day of redemption. That value may exceed or fall short of the invest value depending on the current market value of the bonds held for the selected maturity date.

Another object of the present invention is to provide a full maturity option bond fund that invests in either tax exempt or taxable debt securities.

Additional objects of the present invention will appear as the description proceeds.

The present invention overcomes the shortcomings of the prior art by providing a bond fund wherein the investor has the option of specifying one or more maturity dates for increments of their investment that coincide with maturity dates of debt securities held by the bond fund manager or redeeming their fund units at any time for the unit value determined on the day of redemption. The invention further overcomes the shortcomings of prior art by giving the investors interest payment credits as specified cash value in their fund account, which may be withdrawn or reinvested in the fund. Prior art has only provided for the investor to realize the benefits of interest paid to the fund by realizing increased fund unit values or additional fund units.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### LIST OF REFERENCE NUMERALS UTILIZED IN THE DRAWINGS

10 Full Maturity Option Bond Fund

12 provide investor with prospectus

14 investor completes application

16 investor supplies application and funds

18 investor designates bond fund, amount and interest allocation

20 FMOBF establishes account

22 FMOBF establishes investor's account

24 FMOBF allocates fund units

26 FMOBF updates investor's reinvestment allocation

28 FMOBF credits interest to investor's account

30 FMOBF provides account statement

32 investor provides account changes

34 investor provides reinvestment reallocation

36 investor provides additional funds

38 investor redemption

40 investor redemption meets maturity date

42 FMOBF redeems based on day-of-redemption interest rate

44 FMOBF redeems based on original unit values

50 bond fund purchase transaction processing

52 select bond fund investment processing

54 bond fund purchase processing

56 select bond portfolio

58 enter payment method

60 investor maturity date decision

62 enter amounts to be invested by maturity date

64 enter interest payment or reinvestment allocation

66 investor exits selection and investment process

70 bond fund redemption transaction processing

72 select bond fund redemption processing

74 redemptional decision

76 processing complete

78 enter bond fund investment portfolio

80 enter electronic funds transfer information

82 retrieve maturity date

84 calculate date differential

86 decisional date differential

88 redemption value based on debt security maturity

90 redemption value based on current market value

92 FMOBF investment application

94 investor completed application

96 FMOBF interest calculation

96 FMOBF supplied investor statement

### BRIEF DESCRIPTION OF THE DRAWING FIGURES

In order that the invention may be more fully understood, it will now be described, by way of example, with reference to the accompanying drawing in which:

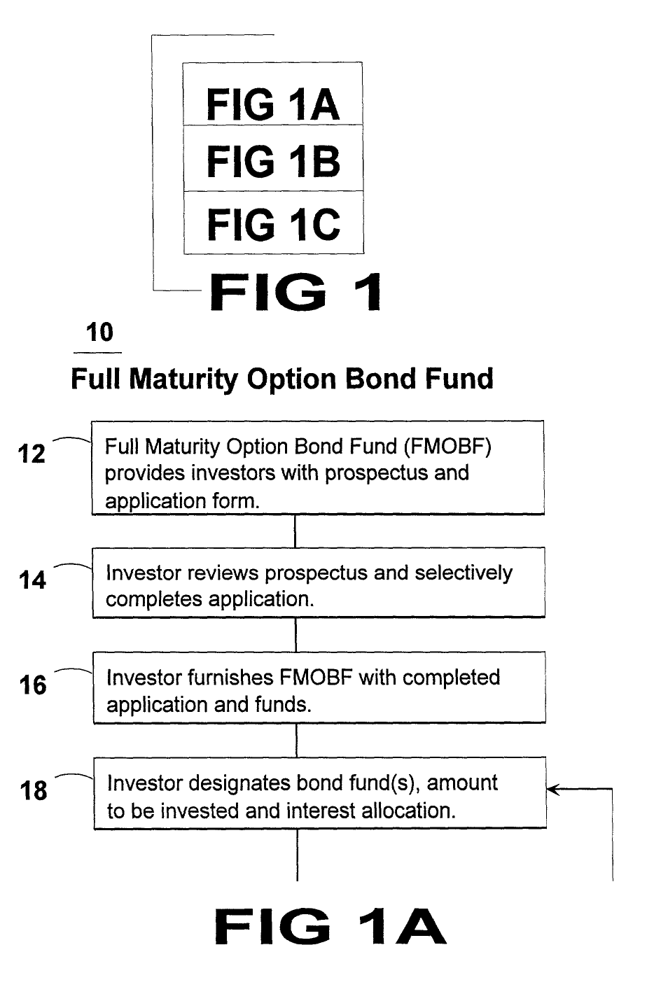

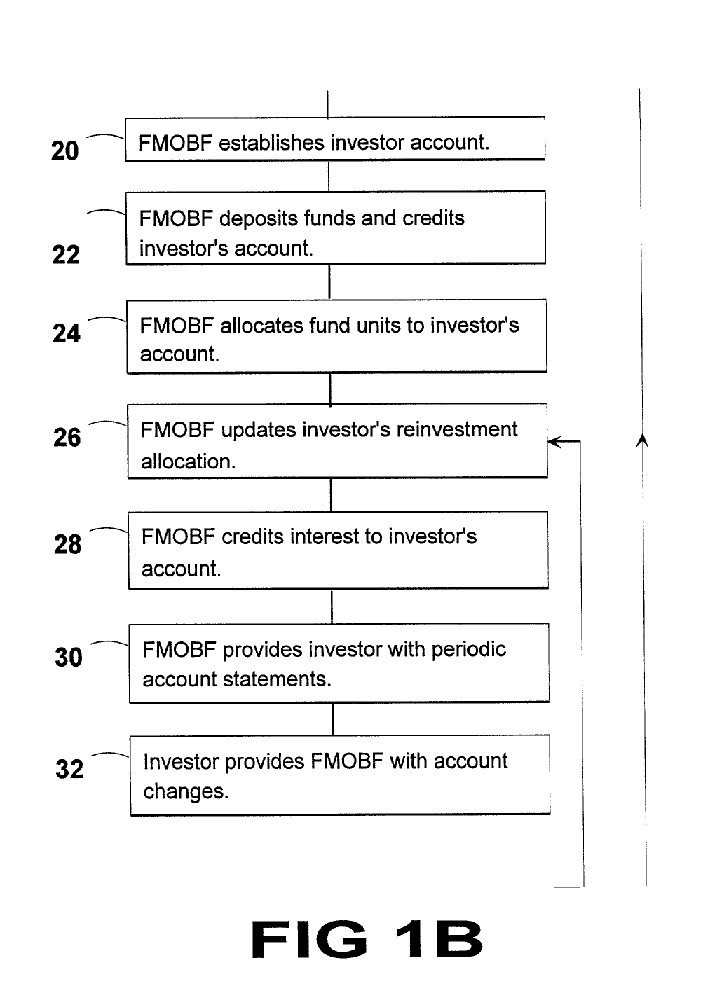

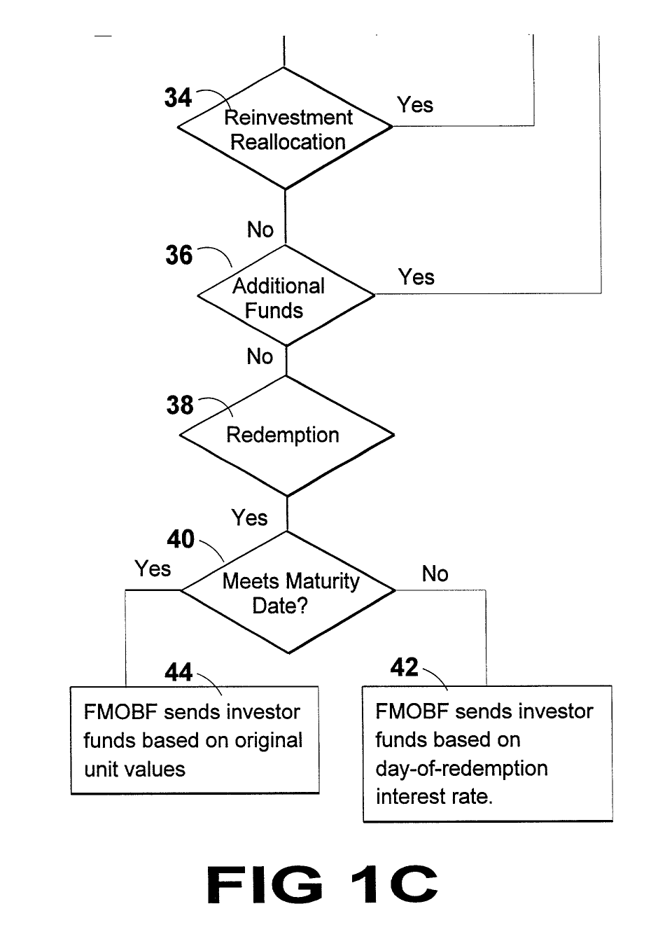

FIG. 1A through IC is a flowchart of the present invention;

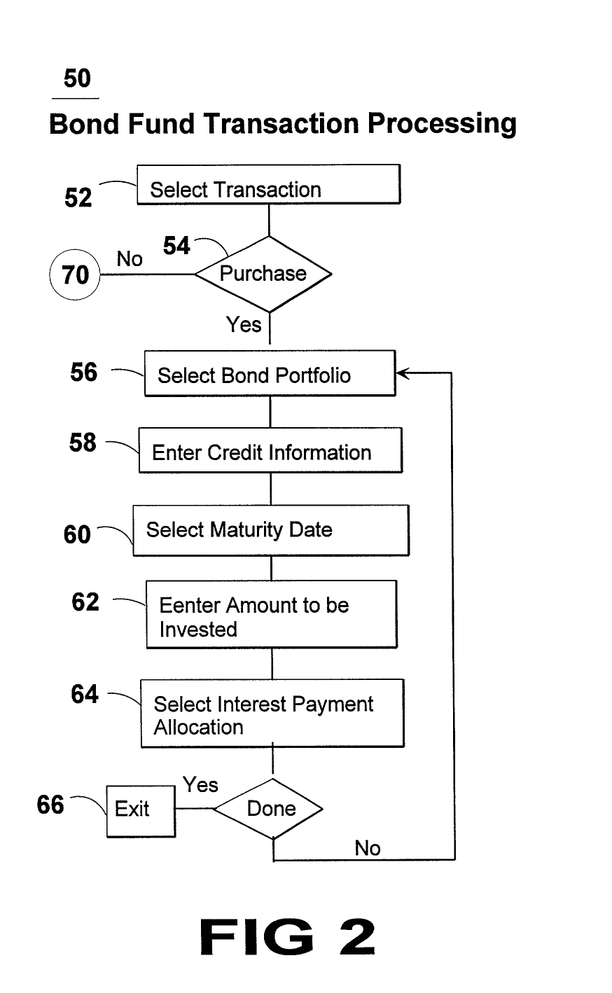

FIG. 2 is a flow chart of the purchase of debt securities.

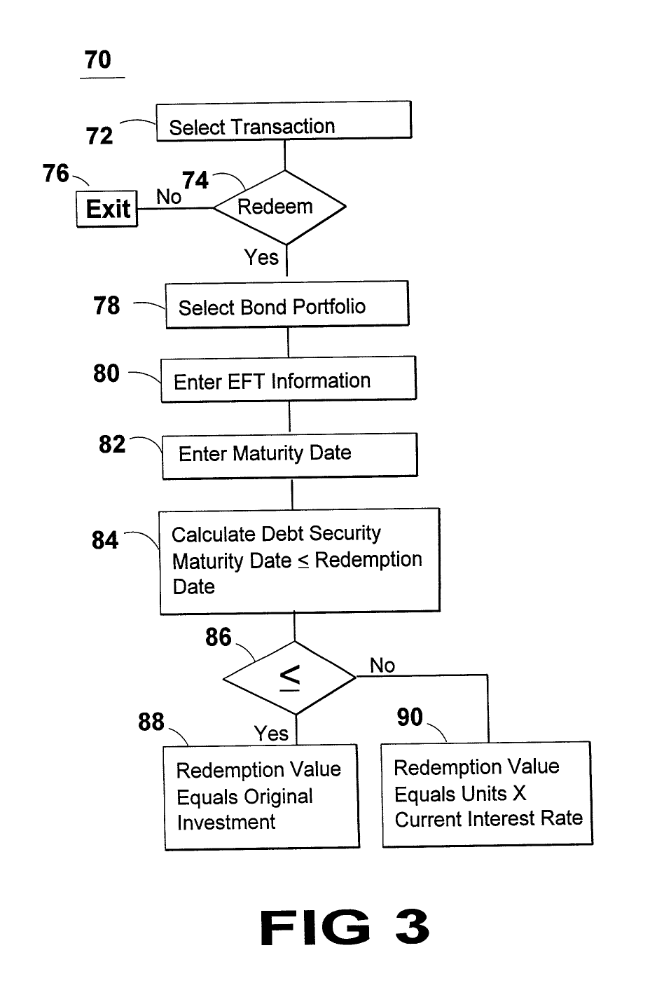

FIG. 3 is a flow chart showing the redemption of investment.

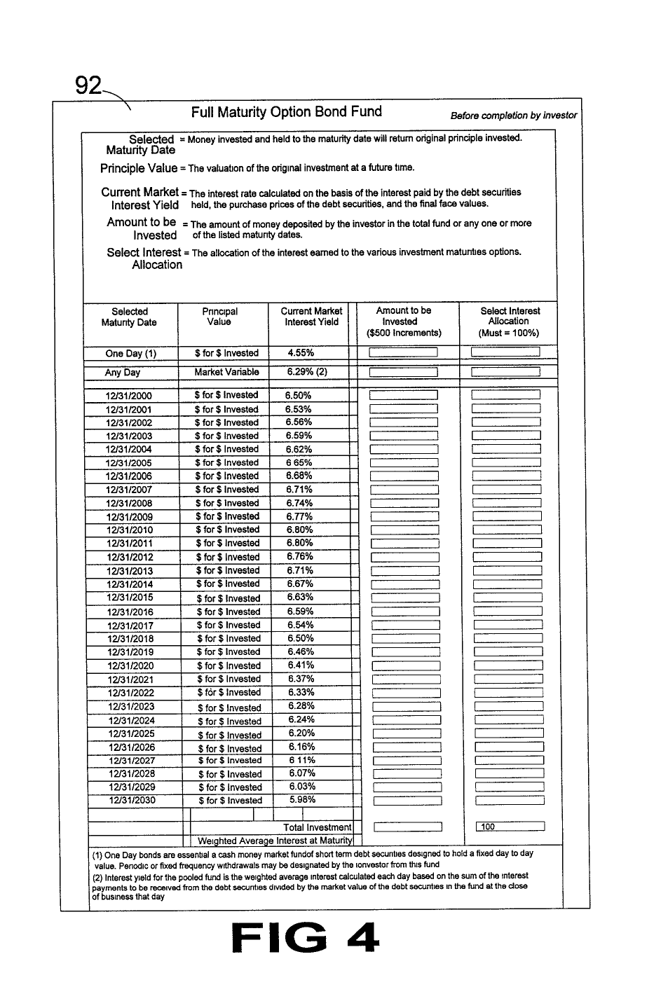

FIG. 4 is an illustrative view of a bond fund data sheet that can be used to record investments.

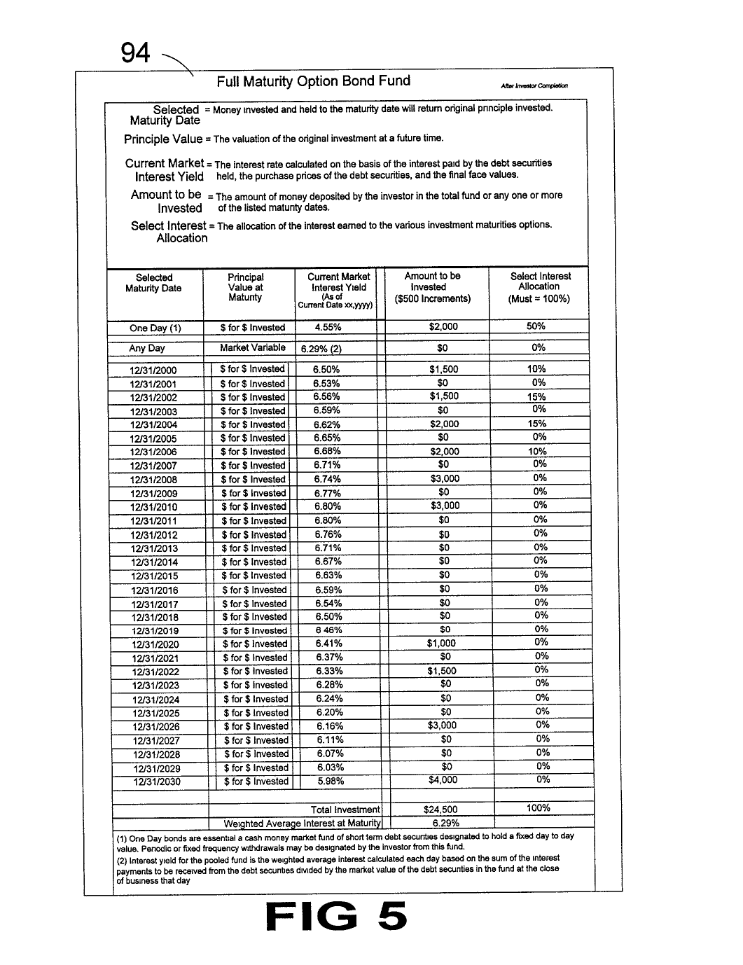

FIG. 5 is an illustrative view of the datasheet as shown in FIG. 4 having a plurality of selectively chosen debt securities.

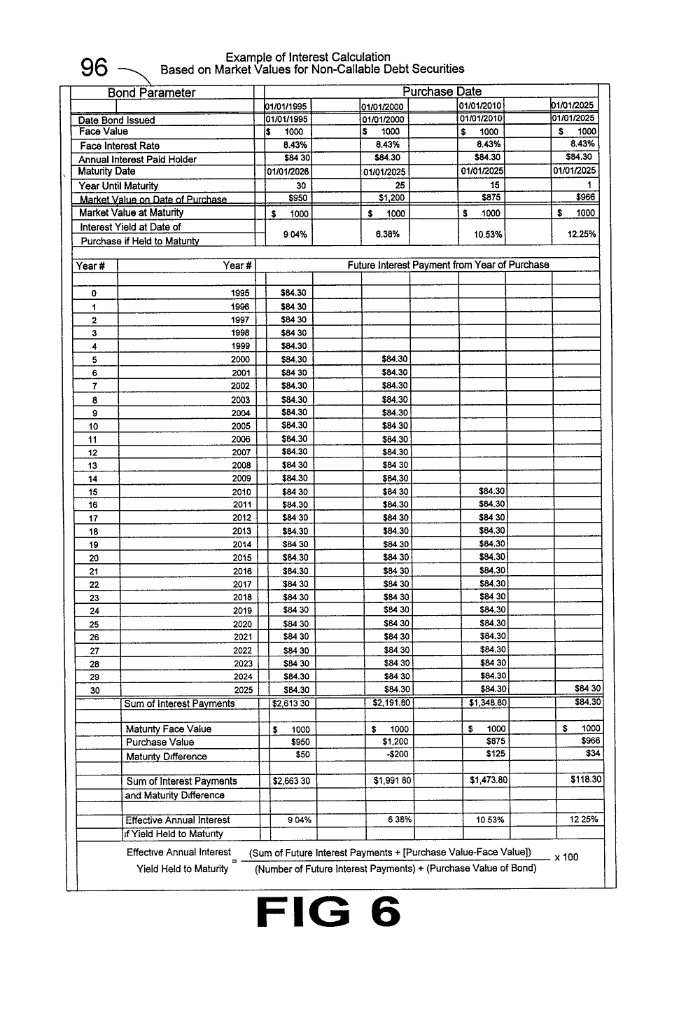

FIG. 6 show a bond fund datasheet showing interest calculation.

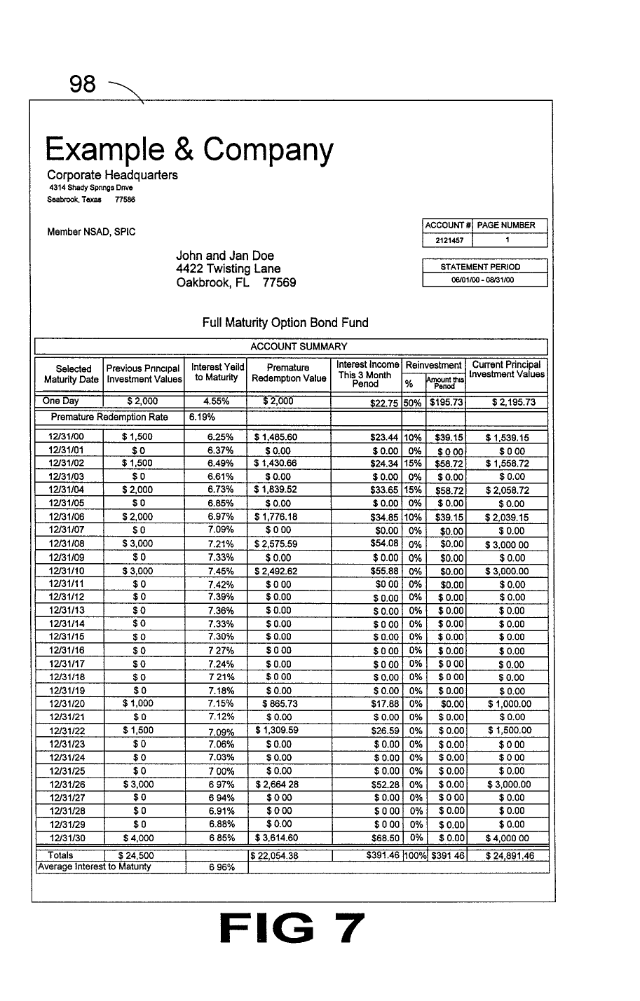

FIG. 7 is a datasheet showing investor investment statement

### DETAILED DESCRIPTION OF THE PREFERRED EMBODIMENT

Turning now descriptively to the drawings in which similar reference characters denote similar elements throughout the drawing figures. FIG. 1 through FIG. 4 illustrate the full maturity bond fund of the present invention indicated generally by the numeral 10.

Referring to FIG. 1A through 1C, one or more investors request through a communications link, personal computer, telephone, fax, mail, etc, a prospectus offering of the Full Maturity Option Bond Fund (FMOBF). The FMOBF provides potential investor's with a prospectus and application form (12) whereby investor's selectively complete the investment application (14) and returns said application and funds to FMOBF 16. Upon review the FMOBF establishes an investor account 20, deposits funds and credits investors account 24 and updates investors reinvestment allocation. At predetermined periods FMOBF credits investor's accounts with bond interest 28 and issues investors with an account statement 30. The investor is charged with maintaining their account information 32 which can include reinvestment reallocation 34, additional investment requests 36, and notice of redemption 38. When the investor chooses to liquidate any bond units, FMOBF will calculate the value of the bond units based on whether the bond fun units have reached date of maturity 40. If the investor's sale request is on or after the bond fund maturity date, then the investor will receive their original investment 44. If the investor's sale request falls before the bond fund date maturity date, then the investor will receive funds based on day-of-redemption interest rate.

While it is not the intent of the present invention to dictate what form of communication will be used between the investor and the bond fund, it is recognized that the Internet provides timely transfer of information, as well as, security in the transfer of confidential information. Therefore, it is felt that the focus of the present invention would be well served within the arena of the Internet whereby investors may complete transaction as need be.

Referring to FIG. 2, shown is the process of purchasing a percentage of a bond portfolio 50. The investor designates what type of transaction is to occur. By specifying a purchasing option 54 the investor is queried to select the bond portfolio 56. After selection of the bond portfolio, the investor will be queried for preferred payment method 58. At this point the investor is queried whether they intend to hold the units until maturity 60. The investor signals that they intend to hold the units until maturity by entering increments of investment within the unit maturity dates offered by the fund 62. This does not obligate the investor to hold the units to maturity. If the investor decides not hold the units until maturity they may enter a redemption request at any time for selling their fund units at the current day's value. The investor next enters instructions for interest payment as designated percentages for cash payments and/or for reinvestment at selected maturity dates 64.

The offer by the bond fund to redeem the investment for full face value will not only encourage investors to hold their investment to maturity but will also stabilize the bond fund.

The advantage of debt securities is that they are income generators. They provide a balance within an investor's portfolio. By crediting interest earnings as a separate cash value line item in the investors fund account the investor will be able to withdraw or reinvest interest while still holding fund units to maturity. By having the option of holding their investment to maturity, the investor will receive at a minimum full face value at redemption. This would also make bond fund investment more attractive to the small investor.

Referring to FIG. 3, shown is the process of redeeming a percentage of a bond portfolio 70. The investor designates what type of transaction is to occur. By specifying a redemption option 72, the investor serves notice that one or more investments are to be redeemed from the bond fund.

The investor selects that portion of their portfolio for redemption. Whereupon they will be queried as to the method and/or criteria for payment 80. The system will retrieve and compare the maturity date as specified when the investment was made 82. If the maturity date was not specified, the redemption value will be calculated as the number of fund unit times the current market value of the fund units 90. If the maturity date was specified and does not coincide with the maturity of the debt security, the redemption value will be calculated as the number of fund unit times the current market value 90. If the maturity date coincides with the maturity date of the debt security the redemption value will be equal to the original investment.

The management fees are continuously calculate with interest payment disbursements and deducted prior to investor disbursements.

Referring to FIG. 4, shown is one method 92 for displaying the bond fund portfolio of the full maturity option bond fund site. The investor is provided with a listing of reinvestment bonds with current market interest yield and the principal value. The investor has the option of selectively entering one or more dollar investment amounts for predetermined debt securities.

Referring to FIG. 5, is an illustrative view of the selectively completed form 94 shown in FIG. 4. Depicted is a view of the bond fund portfolio of the full maturity option bond fund site. The investor is provided with a listing of reinvestment bonds with current market interest yield and the principal value. The investor has selectively entered a plurality of dollar investment amounts and the percentage allocation of the interest earned.

Referring to FIG. 6, shown is an illustrative view of a data sheet 96 showing interest calculations for a registered investor plurality of bond holdings.

Referring to FIG. 7, shown is an illustrative view of a data sheet showing investor holdings 98 managed by the full maturity option bond fund. FMOBF provides investor's with a statement of holdings

What is claimed is new and desired to be protected by letters patent is set forth in the appended claims:

1. A method of full maturity option bond fund comprising:
a) means for listing a plurality of debt securities from a plurality of debt securities issuers;
b) means for selecting from a plurality of issuers debt securities;
c) means for specifying a dollar amount investment to a specific issuer's debt security issuance; and
d) means for specifying a percentage allocation of the interest earned to various investment maturities options.

2. The system of claim 1, wherein said means for listing a plurality of debt securities from a plurality of debt securities issuers includes providing an investor with a list of available debt securities for reinvestment;

3. The system of claim 1, wherein said means for selecting from a plurality of issuer's debt securities includes means for recording of an investors securities selection.

4. The system of claim 1, wherein said means for specifying a dollar amount investment to a specific issuer's debt security issuance includes means for recording an investors dollar amount of investment.

5. The system of claim 1, wherein said means for specifying a percentage allocation of the interest earned to various investment maturities options includes means for recording a percentage allocation of interest earned.

6. A system for full maturity option bond fund comprising:
a) listing a plurality of debt securities from a plurality of debt securities issuers;
b) selecting from a plurality of issuers debt securities;
c) specifying a dollar amount investment to a specific issuer's debt security issuance; and
d) specifying a percentage allocation of the interest earned to various investment maturities options.

7. The system of claim 1, wherein said listing a plurality of debt securities from a plurality of debt securities issuers includes providing an investor with a list of available debt securities for reinvestment;

8. The system of claim 1, wherein said selecting from a plurality of issuer's debt securities includes recording of an investors securities selection.

9. The system of claim 1, wherein said specifying a dollar amount investment to a specific issuer's debt security issuance includes recording an investors dollar amount of investment.

10. The system of claim 1, wherein said specifying a percentage allocation of the interest earned to various investment maturities options includes recording a percentage allocation of interest earned.

11. A data processing system for investing in a full maturity option bond fund, the system comprising:
a) means for receiving data;
b) means for storing data;
c) means for retrieving data; and
d) means for transmitting data.

12. The system of claim 11, wherein said means for receiving data includes:
a) means for establishing a communications link between a host computer and at least one remote user investor computer;
b) means for querying a remote user computer for the purpose of obtaining detailed specification of an investor session;
c) means for receiving electronic transactions from a remote user investor computer;
d) processing means for authenticating remote investor user information; and
e) means for recording remote investor transactions.

13. The system of claim 11, wherein said means for storing data includes means for transmitting remote investors data to a storage media.

14. The system of claim 11, wherein said means for retrieving data includes means for transmitting investor data from a storage media;

15. The system of claim 11, wherein said means for transmitting data includes means for establishing a communications link between a host computer and at least one remote user computer;

16 The system of claim 11 whereby registered investors having a computer possessing Internet access capabilities can view their portfolio.

17. The system of claim 11 whereby registered investors having a computer possessing Internet access capabilities can process transactions including the and acquisition of one or more debt securities.

18. A method for investing in a full maturity option bond fund by registered investors comprising the steps of:
a) receiving investor data;
b) storing investor data;
c) retrieving investor data; and
d) transmitting investor data;

19. The method of claim 18, wherein said receiving investor data includes:
a) establishing a communications link between a host computer and at least one remote registered investor computer;
b) querying a remote registered investor computer for the purpose of obtaining detailed specification of a registered investor session;
c) receiving electronic transactions from a remote registered investor computer;
d) authenticating remote registered investor information; and
e) recording remote registered investor data.

20. The method of claim 18, wherein said storing registered investor data includes transmitting remote registered investor data to a storage media.

21. The method of claim 18, wherein said retrieving registered investor data includes transmitting remote registered investor data from a storage media;

22. The method of claim 18, wherein said transmitting registered investor data includes establishing a communications link between a host computer and at least one remote registered investor computer;

23. The method of claim 18 whereby said registered investor having a computer possessing Internet access capabilities can process transactions online.

24. The method of claim 18 whereby any interested party having a computer possessing Internet access capabilities can view a list of debt securities for reinvestment.

25. The method of claim 18 whereby any interest party having a computer possessing Internet access capabilities can invest in the posted debt securities.
